(19) United States
(12) Patent Application Publication
(10) Pub. No.: US 2013/0317882 A1
(43) Pub. Date: Nov. 28, 2013

(54) AUTOMATED AUCTIONING OF EXCLUSIVE COMMUNICATION RIGHTS TO SUBSET POPULATIONS

(71) Applicants: Wayde Fleener, Bloomington, MN (US); Jon Earl Von Rentzell, Chanhassen, MN (US); Henry Fredrick Boubelik, III, Eagan, MN (US); Daniel W. Mallin, Minneapolis, MN (US); Justin W. Cox, New Brighton, MN (US); Charles D. Park, Palm Harbor, FL (US)

(72) Inventors: Wayde Fleener, Bloomington, MN (US); Jon Earl Von Rentzell, Chanhassen, MN (US); Henry Fredrick Boubelik, III, Eagan, MN (US); Daniel W. Mallin, Minneapolis, MN (US); Justin W. Cox, New Brighton, MN (US); Charles D. Park, Palm Harbor, FL (US)

(73) Assignee: Carlson Marketing Worldwide, Inc., Minneapolis, MN (US)

(21) Appl. No.: 13/703,819

(22) PCT Filed: Jun. 14, 2011
(86) PCT No.: PCT/US11/01068

§ 371 Date: Aug. 13, 2013

Related U.S. Application Data
(60) Provisional application No. 61/354,503, filed on Jun. 14, 2010.

(51) Int. Cl. G06Q 30/08

(52) U.S. Cl. CPC G06Q 30/08
USPC 705/7.29

(57) ABSTRACT

In an example, a method includes defining a subset of one or more individuals records, wherein the individual records are stored in a population database; creating an auction record in an auction database for the subset, wherein the auction record stores data representing a period of time and a conversion metric for the one or more individuals in the period of time, and wherein the period of time is an exclusive period of time for communicating to the subset population; evaluating the conversion metric for the one or more individual records during the period of time, wherein the one or more individuals records are classified as converted or non-converted based on the evaluation; and based on the evaluation, extending the first period of time for a portion of the one or more individuals records that are classified as converted.

### CLAIM OF PRIORITY

This application claims the benefit of priority under 35 U.S.C. §119(e) to U.S. Provisional Application Ser. No. 61/354,503, filed Jun. 14, 2010, which is hereby incorporated by reference herein in its entirety.

### BACKGROUND

Many companies have marketing Programs which facilitate marketing communications on behalf of Partners and affiliates.

### BRIEF DESCRIPTION OF THE DRAWINGS

Some embodiments are illustrated by way of example and not limitation in the figures of the accompanying drawings in which:

FIG. 1 is a flowchart diagram according to an example embodiment;

FIG. 2 is network diagram, according to an example embodiment;

FIG. 3 is a diagram of an architectural overview, according to an example embodiment;

FIG. 4 is a diagram of a database model, according to an example embodiment;

FIGS. 5-6 are tracking workflow diagrams, according to example embodiments,

FIGS. 7-10 are user interfaces, according to example embodiments;

FIGS. 11-16 are data flow diagrams, according to example embodiments;

FIGS. 17-18 are user interfaces, according to example embodiments;

FIG. 19 is a flowchart, according to an example embodiment;

FIG. 20 is a system, according to an example embodiment; and

FIG. 21 illustrates a computer system, according to an example embodiment.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are illustrated in enough detail to enable those skilled in the art to practice the invention. The embodiments may be combined, other embodiments may be utilized, or structural, logical, and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

A challenge with existing marketing programs that facilitate marketing communications on behalf of Partners and affiliates is that Partners and affiliates are often competitors leading to conflicting messages received by consumers and a diluted value proposition for the Partner. One possible solution for these challenges is to select one Partner that has exclusive rights to market to consumers. Currently, there is not an efficient process to: maximize revenue to the company in the sale of exclusive rights to Partners; offer Partners flexibility when selecting consumers they are interested in communicating with; and track the results of exclusive marketing efforts in a way that allows Partners to continue to market to consumers they have converted. While the following system Framework is discussed in the context of loyalty rewards, the Framework is not limited to such a use and has applicability to other Partnership/affiliate marketing programs or advertising platforms in general.

In various embodiments, a loyalty program finds Partners who agree to buy points at a pre-defined amount from the loyalty program and then the Partner gives those points to the Partner's customers for some activity. Points are used as a generic term for currency in a loyalty/affiliate marketing program. For example, points may be counted as miles. An example is a car rental Partner in an airline program. The car rental company agrees on a set price for purchasing points from the airline loyalty program. Then, the Partner creates an offer such as, every time a loyalty program member rents a car from the Partner, the Partner will give the loyalty program member a set number of points.

In an example embodiment, the Partner and loyalty program negotiate a price per point purchased. The Partner identifies to the loyalty program which loyalty program members to give points to and how many points to award. For example, if an airline loyalty program member rents a car from a Partner, the loyalty program member tells the car rental company their loyalty program member ID. Then the car rental company captures and transmits back to the loyalty program the loyalty member ID and points to issue to the loyalty program member. Thereafter, for each point/mile purchased, the Partner pays the loyalty program the agreed set amount. The loyalty program member now has the points credited to their account. The loyalty program holds the liability for the points issued to the loyalty program member (liability is the expected cost for all points that are expected to be redeemed in the future). When the loyalty program member redeems, the loyalty program is responsible for the cost incurred for redemption.

In various embodiments, the loyalty program makes money from Partnership marketing in various ways. For example, it may make money by the difference between the price the Partner pays for a mile/point and what it costs to fulfill on the mile/point (when a loyalty program member redeems, the cost for that redemption). Another possible way is by the breakage on points which is the difference between points issued and the actual number of points redeemed. Yet another is by any fees a Partner pays for the right to communicate to the loyalty program members (for example, if a Partner wants to send an offer to the loyalty program members they typically have to pay the loyalty program for access to send that offer). A final example is by any fees a Partner pays for exclusivity if they want exclusivity in a Partner category (for example, a credit card Partner will pay the loyalty program a fee to be the exclusive credit card of the loyalty program or will pay a higher price per point/mile than if they were not exclusive).

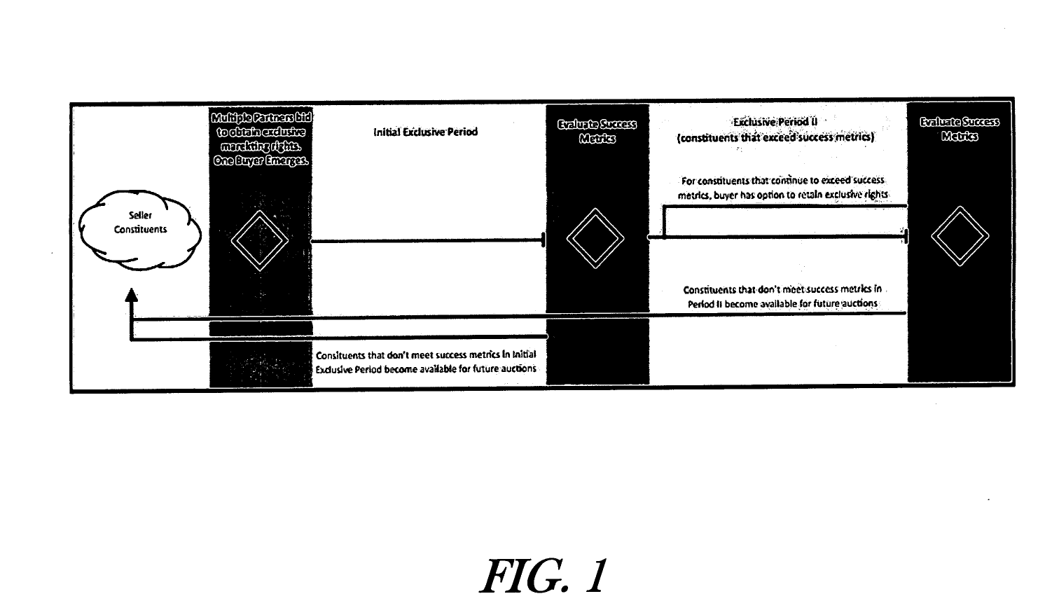

In an example embodiment, a Framework is used which facilities the auction of exclusive rights to communicate to sets of Individuals in loyalty programs. In the context of this Framework, exclusive may mean totally exclusive or exclusive in an industry/category. For example, a car rental company may buy exclusive communication rights for just the car rental category or exclusive communication rights for all Partners. Additionally, in various embodiments the loyalty program is still able to communicate and market to their own members (sometimes referred to as Individuals) despite the exclusivity given to one or more Partners. FIG. 1 illustrates an example flow diagram using the Framework.

In various example embodiments, terminology for the auction system is as follows. A Seller is an entity (e.g., an airline) that has the right to communicate with its constituent population on behalf of other entities. In this document, the Framework in which a Seller communicates with their constituent population is sometimes referred to as a Program (e.g., a Loyalty Marketing Program). A Partner is an entity (e.g., a car rental company) that is interested in obtaining exclusive marketing and communication rights for constituents of a Seller running a Program. A constituent that a Seller communicates with on behalf a Partner may be referred to as an Individual. Communication and marketing (throughout the document these two terms are used interchangeably) methods may include, but are not limited to, offers (e.g., 1000 bonus points), promotions, coupons (e.g., 10% of), e-mail, phone, direct mail, display advertising on the Seller's website, display advertising on a third party website, display advertising on a Partner website, social media, SMS, MMS, browser toolbars, mobile applications on mobile devices, or kiosks. Individuals may be grouped into Subsets based on information a Seller knows about an Individual including past and/or predicted future buying behavior.

In an example embodiment, an airline is considered the Seller. The airline has a loyalty marketing program that is considered the Program. Individuals participating in the Program are grouped into Subsets. For example, one subset may include Individuals that fly at least 1,000 miles a month. The Subsets are made available to Partners, (e.g., a car rental company) via auction. The Partner that wins the auction then receives exclusive marketing and communication rights for a predetermined period of time to the Individuals included in the won Subset.

In various embodiments, Subsets are periodically available for auction to a group of Partners that compete in a given industry. The same Subsets may be auctioned to Partners in multiple industries. For instance, if an airline was the Seller, they may auction their Subsets to an audience of car rental Partners, as well as an audience of hotel Partners.

Once a Partner wins an auction, they become the Buyer for the given Subset of Individuals for a predetermined exclusive period of time. During the exclusive period, the Seller may market and communicate to the Subset on behalf of the Buyer. Once the exclusive period has ended, if the Buyer meets predetermined metrics for success, the Buyer may have the option to renew its exclusive period for those Individuals or Subsets that have met the metrics for success (e.g., an Individual that has been converted or if enough Individuals within a Subset are converted). In various embodiments, the Buyer will have earned the right to have an indefinite exclusivity period for the converted Individuals or Subset. In other embodiments, an additional fee may be required to continue the exclusivity period. In yet another embodiment, the Buyer may have a right of first refusal to converted or non-converted Individuals or Subsets. Combinations of differing fee arrangements and lengths of time may also be implemented.

Metrics for success may vary between Subsets, Programs, and Sellers. Success may also be referred to as Conversion. Conversion may be considered on the Subset or Individual level based on the actions of Individuals within the Subset. In an example embodiment, metric refers to actions taken by the Individual. For example, an Individual within a Subset is Converted when he or she completes a purchase with a Partner, and in the process of making that purchase, also earns points in the Loyalty Program of a Seller. A conversion is not necessarily tied to an Individual making a purchase. In another example, an Individual may view an online learning module followed by attending a seminar to be considered converted. In yet another embodiment, visiting a Partner's website may be considered a Conversion. When conversion is decided at the Individual level, a Partner retains the exclusive right to market to Converted Individuals after the initial period of time. The non-converted Individual may be available for auction in further Subsets. In various embodiments in which Conversion is determined at the Subset level, if enough Individuals within the Subset are Converted, the entire Subset is considered Converted. Thus, the Partner retains the exclusive right to market to all Individuals in the Subset, not just the ones that may have individually been converted. The threshold amount of Individuals within a Subset that need to be Converted before the Subset is Converted may vary from auction to auction.

Structural Overview

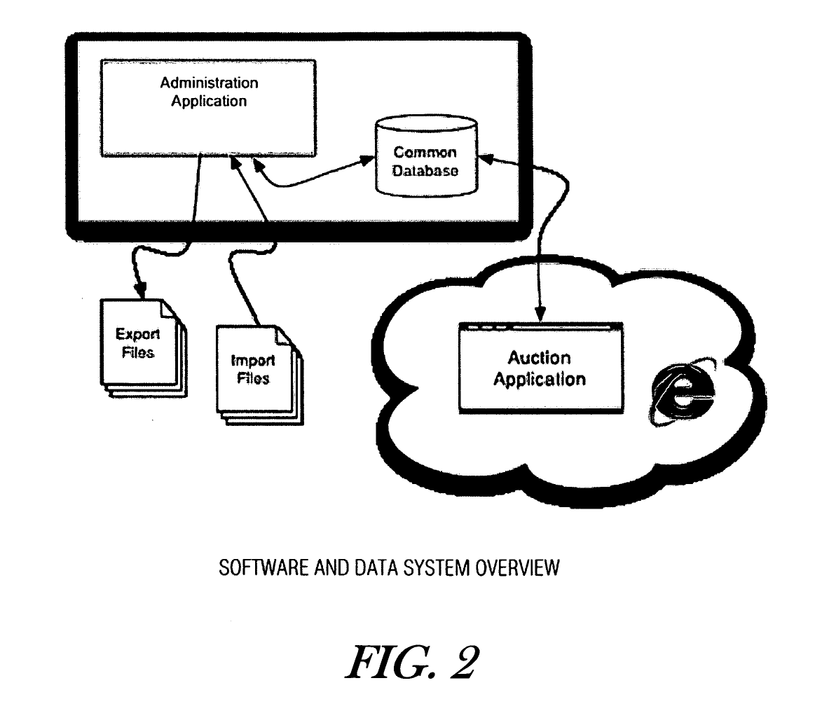

In an example embodiment, FIG. 2 diagrams an example of an exclusive marketing and metric tracking Framework (hereinafter Framework). The Framework consists of two primary applications: (1) an Administration application, a hybrid client used to maintain administrative functions such as user access, invoice control, external file management, accessing and maintaining a core database, analyze and develop auction Subsets, import and export datasets, and to track conversion for purchased Subsets, and (2) an Auction application, a web-based thin client used by the Partner participants to view available Subsets, bid on available Subsets, and to view on-going activity. In addition, in an example embodiment, the Auction Application is the portal through which Sellers view post-auction metrics in order to track performance of Partners, Subsets, and Individuals.

In various embodiments, the Administration application and Auction application are executed on one or more computers (e.g., personal, mobile, server). In an example embodiment, the computers include one or more processors, display, network interface, memory, one or more applications stored on the memory, and an input interface. Input interfaces may include touchscreens, a keyboard, a stylus, gesture control, or voice control. Network interfaces include interfaces capable of receiving and sending data such as wireless interfaces CDMA, GSM, WI-FI, WiMAX, or wired interface such as Ethernet or USB. The processor executes instructions stored on the memory to provide the functionality described herein.

In various embodiments, data is stored and maintained using a common centralized database structure (common database). The database may be distributed across multiple machines. External files are loaded through a common interface and conform to predefined flat structures for input. Any type of ETL (extract, transform, or load) work is accomplished within the Administration application and is automated for performance and consistency.

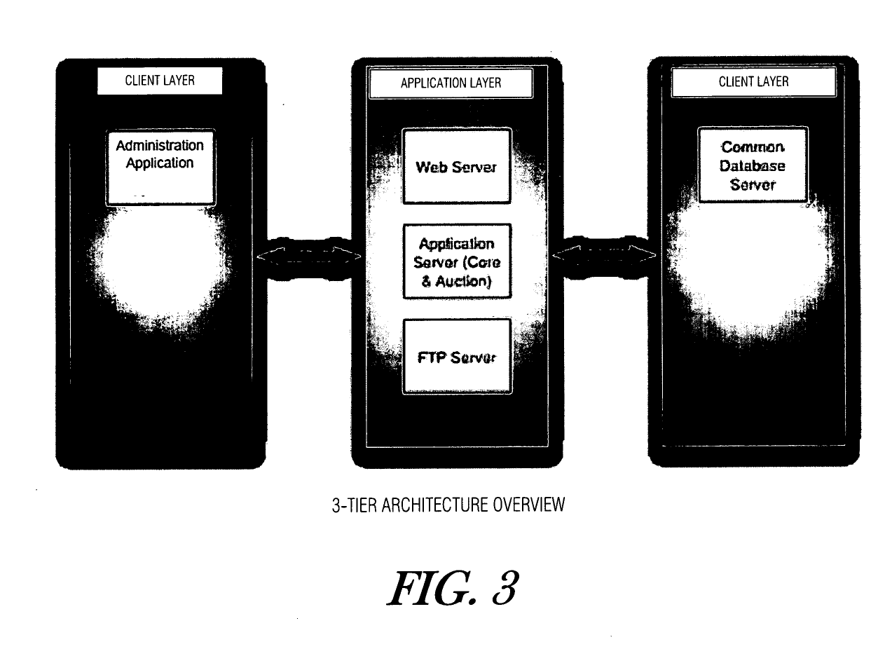

FIG. 3 is a diagram of an architectural overview, according to an example embodiment. In an embodiment, the Framework includes a three-tier architecture consisting of a database layer, an application layer, and a client layer. This allows for efficiencies in processing, as well as allows for code changes within one layer without affecting the others.

In an example embodiment, the application layer maintains the primary application middleware server, as well as houses the web server and FTP server. The web server functions to deploy the Administration application and to house the web-based Auction application. The FTP server functions as the repository for incoming and outgoing files, allowing Sellers to post updated activity files for Individuals and to receive Subset containment files, and an output file notifying the Seller of the Individuals affected and of the terms applied.

In an example embodiment, the client layer consists of the Administration application and functions as a hybrid client, with the majority of processing being passed to the application layer. Invoicing and low-impact reporting is processed at the client for efficiency and performance purposes.

In an example embodiment, the database layer handles the data work and is a dedicated database server and engine performing all data computing needs.

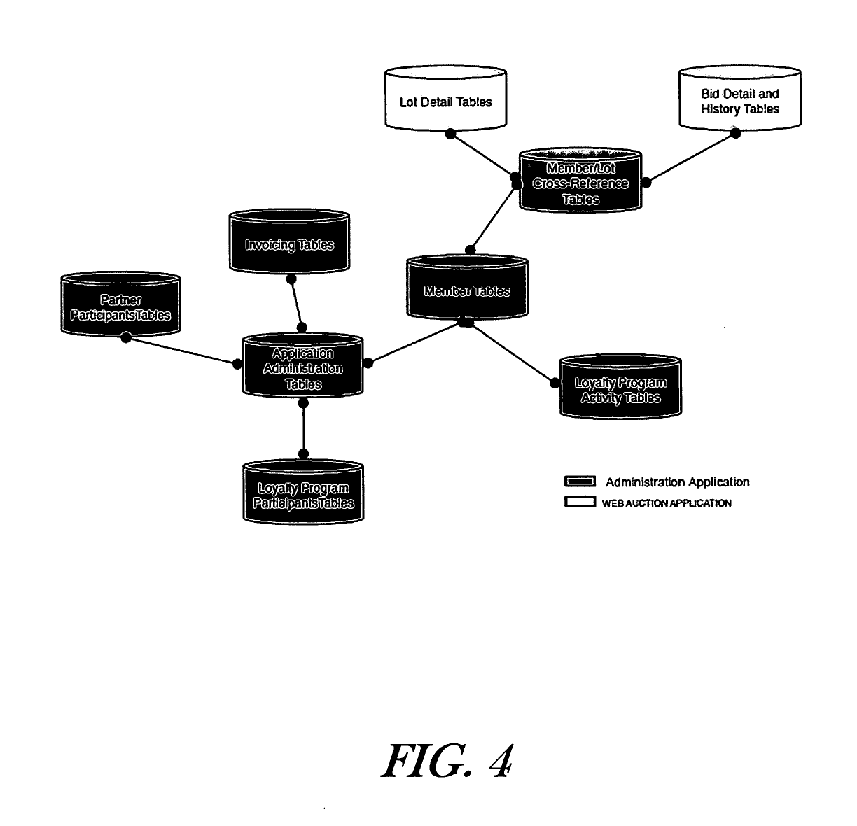

In an example embodiment, data from a Seller is stored using a single database instance. Access to each Seller's data will be determined within the administration model and can be limited as needed. In other embodiments, multiple or distributed databases may be used. FIG. 4 is a diagram of a data model, according to an example embodiment. In an embodiment, the “lots” in FIG. 4 are considered the Subsets described above. Each of the tables may include information related to the framework that may be updated at various points in the auctioning process. For example, the details of a Subset that may be stored include, but are not limited to: Program ID, Subset description, Winning Partner identification, Exclusivity Start and End Dates, and Approval status. In various embodiments, the details of the Subset also includes a Conversion status. A record of an Individual (illustrated as a member in FIG. 4 and other FIGS.) may have field storing information including, but not limited to: Conversion status, Current Point Balance, Number of Points Awarded, Points from Partner, and a Winning Partner Identification. In an embodiment, information in a record (e.g., auction, lot, individual) may be organized into one or more datafields (e.g., an identity datafield, a conversion datafield).

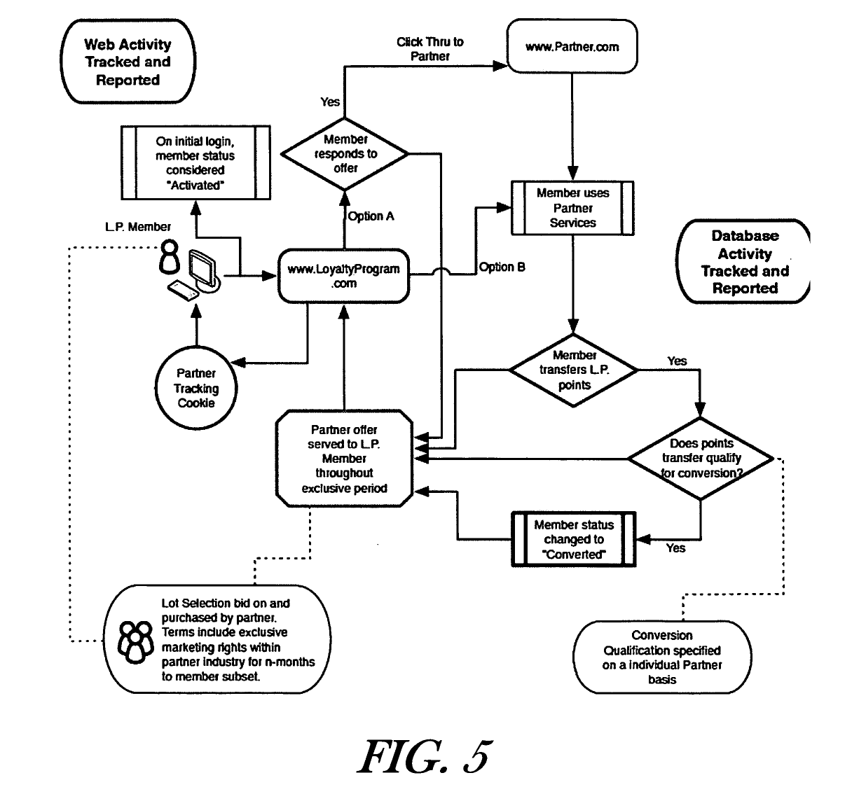

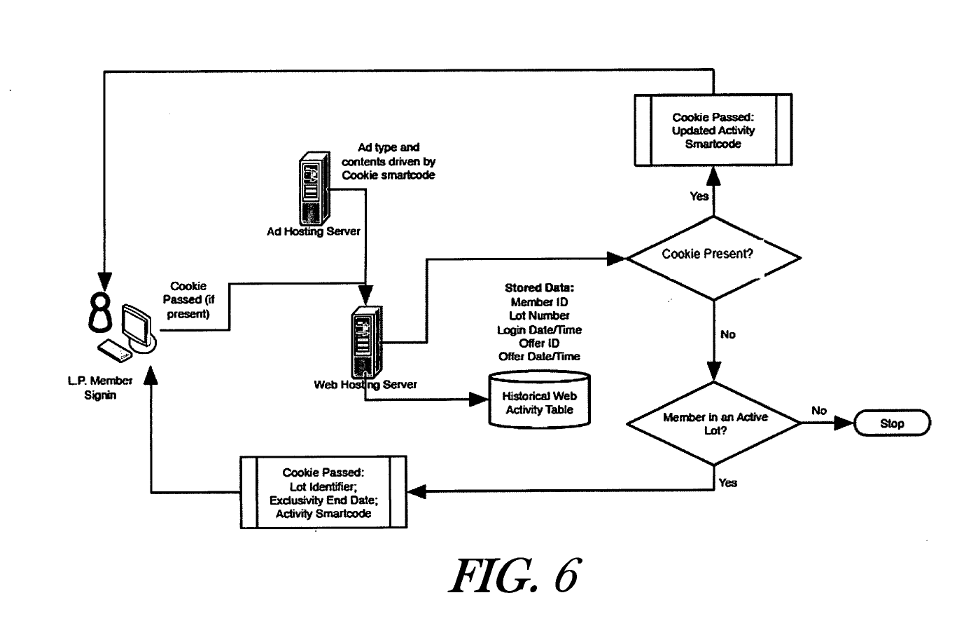

FIGS. 5-6 illustrate an example workflow for tracking the Conversion of an Individual. In various embodiments, one feature of the Framework is identifying and tracking Individuals of the Subset within an overall Program population. Additionally, Conversion metrics are accessible to both the Partner participants as well as the Seller participants.

In an embodiment, once a Subset is purchased in an auction, the underlying terms of the purchase agreement may be exclusive marketing privileges to the Individuals of the Segment within the Partner's core industry for a set period of time. If, during that period, an Individuals' activity qualifies under the Conversion specifications, then the Individual is flagged as a Conversion. In an embodiment, flagged signifies one or more database tables referencing the Individual being updated.

In an embodiment, through the use of an activity-tracking cookie on the Individual's computing device, the Framework is able to provide additional features. In various embodiments, an http cookie is deployed to the Individual's computing device when (1) the exclusivity period has initiated, and (2) the Individual visits the Seller's web site. An expiration date is included with the cookie for tracking and offer management purposes and is set to the exclusivity end date specified in the Subset auction terms. The cookie may be used to determine which communications from Partners to serve up to the Individual.

In an embodiment, Partner's have access to the cookie (or a separate cookie) in order to serve ads to the Individual through various ad networks. For example, consider the example of when an airline loyalty program sells the exclusive advertising rights of a subset of Individuals to a car company. When an Individual in the subset visits a webpage of the airline a cookie may be transmitted to the Individual identifying him/her as a member of the auctioned subset. Then the car company is given access to present advertisements to the Individual in participating advertising networks (e.g., those that are able to use the cookie).

In various embodiments, evaluation of the Partner Transaction Table on the database will enable the Framework to calculate relevant performance metrics on an on-going basis, both for an active Subset, as well as for comparison to past Subsets and cross-Partner activity.

In an example embodiment, Conversion and tracking metrics for Individuals and Subsets are reported in a predefined format. The following format is an example information that may be included in the reports.
Total Number of Offers Served: A running total of all offers, by offer, presented to Individuals within Subset selection.
Number of Individuals Activated: A running total triggered when an Individual is served an offer, by offer (considered “activated”).
Number of Individuals Converted: A running total triggered when an Individual qualifies as “Converted,” reported by offer
Percentage of Subset Activated (%): Total Number in a Subset Selection Group/Number of Individuals Activated
Average Number of Offers Served per Individual: Total Number of Offers Served/Number of Individual Activated
Click-Thru Rate (%): Number of Activated Individual clicking on Offer/Number of Individual in Subset
Cost per Activated Individual ($): Purchase Price of Subset/Number of Individuals Activated
Cost per Conversion ($): Purchase Price of Subset/Number of Individual Converted
Average Time to Conversion: Total number of days for all conversions/Number of Individuals Converted
ROI (Seller): (Revenue from Points sold to Partner for Subset+(Subset Purchase Price−Subset Sale Commission))/(Subset Sale Commission+Total Conversion Commission)
ROI (Partner): NPV of Converted Individuals/Subset Purchase Price

In an example embodiment, an Individual will be considered converted when the conversion amount threshold, uniquely specified for each Seller/Program/Subset Partner combination, is met. A comparison between the Number of Points Awarded amount at the onset of the exclusivity period and the Number of Points Awarded amount after each table update will trigger the event. In an embodiment an Individual is converted when the current number of points awarded minus the historical number of points awarded is greater or equal to a defined Conversion amount. In various embodiments, conversion is based on criteria other than points. For example, a member may be considered converted based on an amount spent with a partner, number of transactions with a partner, or time (e.g., time spent on a partner's website). In an embodiment, a Subset is converted when a certain percentage of the Individuals are converted.

Administration Application

In an example embodiment, the Administration Application is the primary tool for the administrators of the overall Framework. It operates as the master interface between the database and the auction site controlling user access and functions as the analytical and product/subset development tool between the Loyalty Program and the Partner. For the majority of the work, the Administration application serves to automate file management and allows for quick deployment of common functions by storing configuration parameters for Subset development, placement of Subsets for auction, and invoice management.

In various embodiments, the administration application includes many features. For example, it includes multiple user levels, including, but not limited to, Administrator, Super User, and General User. In an example embodiment, the Administrator level is the highest level. This user type can add, delete, or modify Sellers, Partners, or Users within the Administration application and the Auction Tool. The Super User type can access all data, regardless of industry or Seller, and can create and post Subsets for auction within any industry or for any Seller. If permissions are granted, the Super User level has the capability to import or export data, and can approve developed Subsets for auction posting. The General User type can only access limited data, specified during the user creation configuration, and typically will be limited to a single industry, Seller, or Program. The General User level can only create and post Subsets for auction within these limitations. If permissions are granted, the General User level has the capability to import or export data and can approve developed Subsets for auction posting.

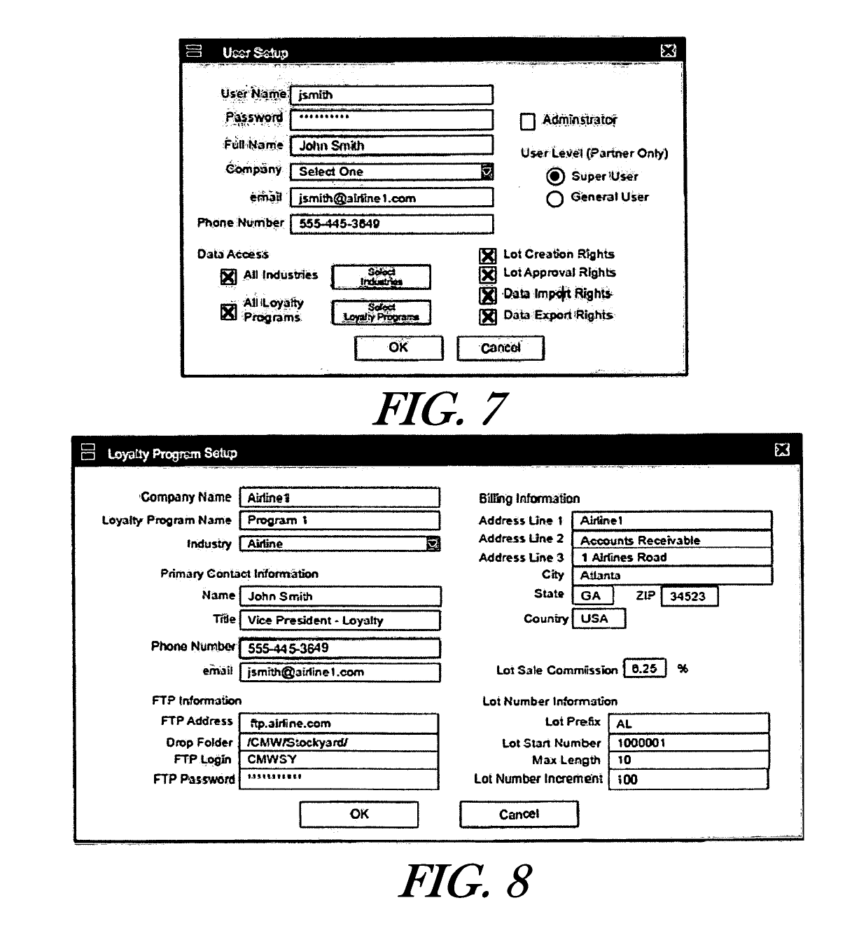

Data import and export capabilities can be granted or revoked depending on the needs of the user. Subset approval privileges (for auction posting), can be granted or revoked depending on the needs of the user. Also, in various embodiments, a user may not approve a self-created Subset. In this scenario, a second person with appropriate privilege makes the final approval before the Subset is posted for Auction. FIG. 7 is an example user interface for setting up a user.

In an example embodiment, the login feature of the Administration application uses a unique User ID and Password. Users are initially setup and activated by an administrator of the Framework.

In an example embodiment, another feature of the Administration application is the user experience/dashboard. Super Users have access to all industries and to all Seller data. General Users are assigned access to specific industries, Sellers, or Programs, and only have access to data and Subsets specific to their configuration. On login, all users are presented with an account dashboard detailing current activity Dashboard includes: Open Auctions, Upcoming Auctions, and Closed Auctions.

Additionally, in an example embodiment, prior to any type of data loading or analysis, an administrator level user creates an account for each Seller, specifying the identifying information, as well as the commission levels for invoicing purposes. FIG. 8 is an example user interface for setting up a loyalty program.

Each Seller is assigned a unique Subset prefix and given Subset number generator parameters (start number, length).

| Loyalty Program | Subset | Start | | |
|---|---|---|---|---|
| Name | Prefix | Number | Length | Sample Subset # |
| ABC Airlines | ABC | 10000001 | 10 | ABC10000657 |
| DEF Airlines | DEF | 273659 | 10 | DEF00273660 |

In various example embodiments, for each Seller account, FTP parameters are stored for automated file transfer of Subsets. The FTP parameters may include, but are not limited to, Address, User Name, Password, and Folder Location.

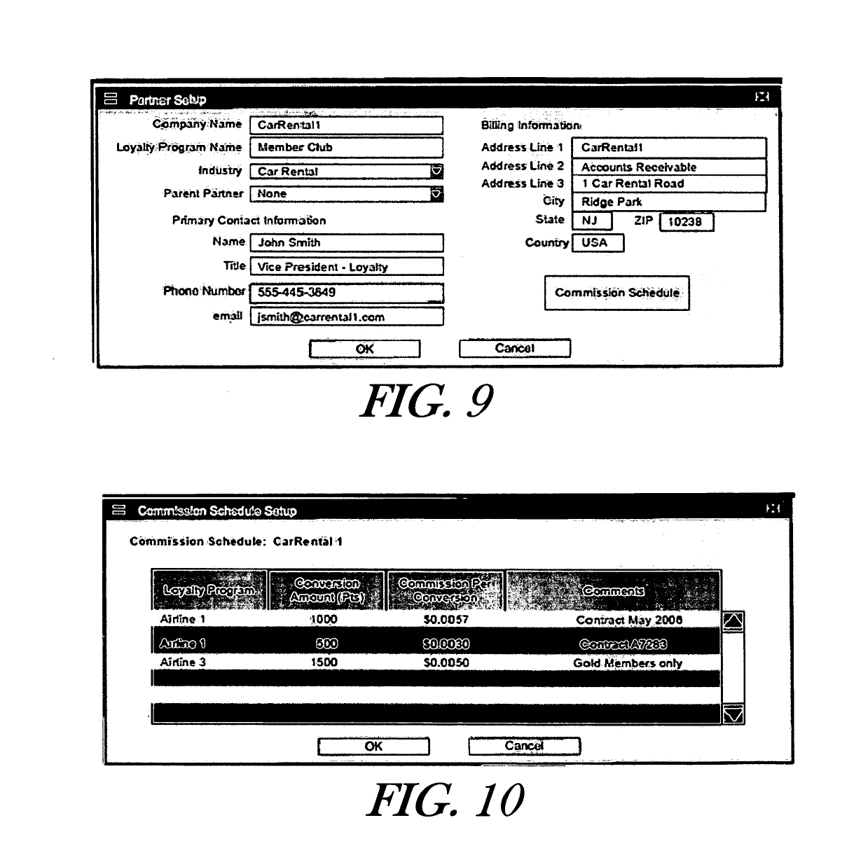

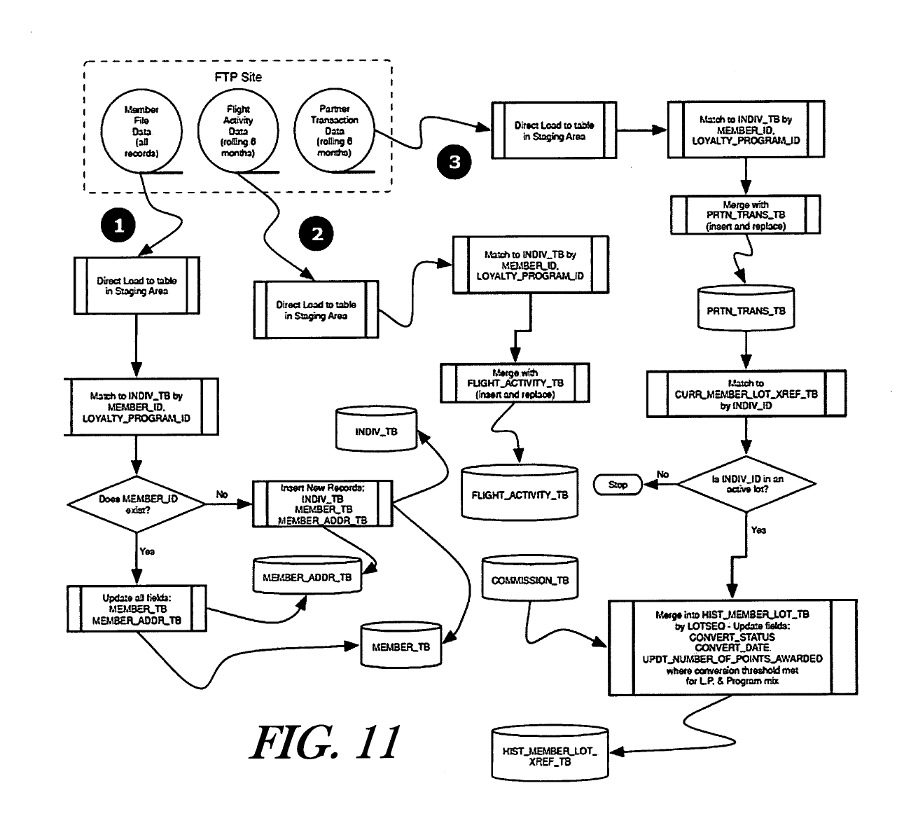

In further embodiments, an administrator lever users creates an account for each Partner. FIG. 9 is an example user interface for setting up a Partner. The Partner is then able to login and view open bids (within the Auction portal). A Partner Account will also specify parent Partner information for invoicing purposes. In an example embodiment, each Seller/Partner combination will have a unique commission schedule configuration, allowing for variances in the conversion thresholds and payment levels negotiated between the two parties. For those Partners identified as a child (with parent Partner entity), the Commission Schedule developed for the parent will apply (non-configurable for the child Partner). Parameters entered may be, but are not limited to: Conversion Amount, the threshold amount of loyalty points purchased by the Partner upon which an Individual is identified as “Converted;” and Commission Per Conversion, the amount payable to a third party (e.g., the administrator of the Framework) for each converted member. FIG. 10 is an example user interface of a commission schedule setup.

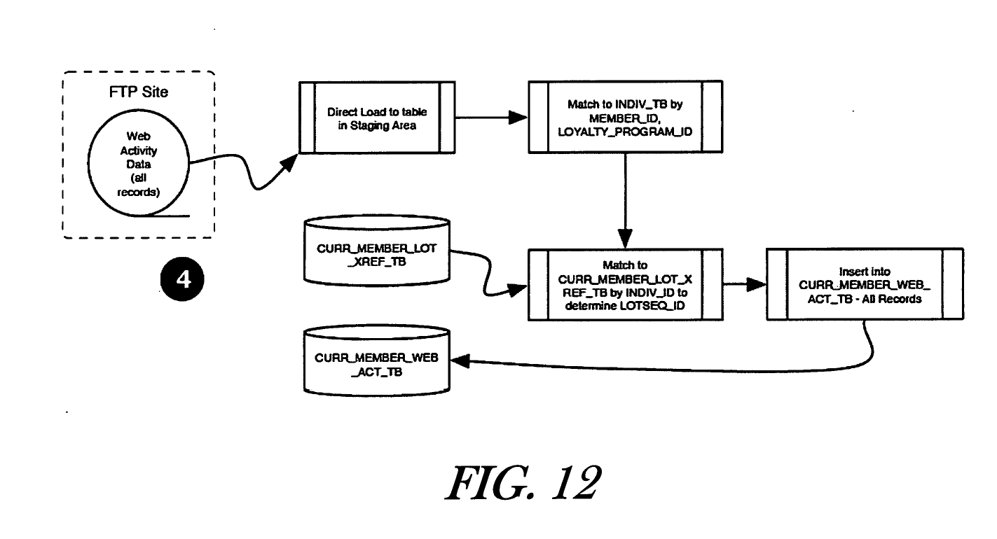

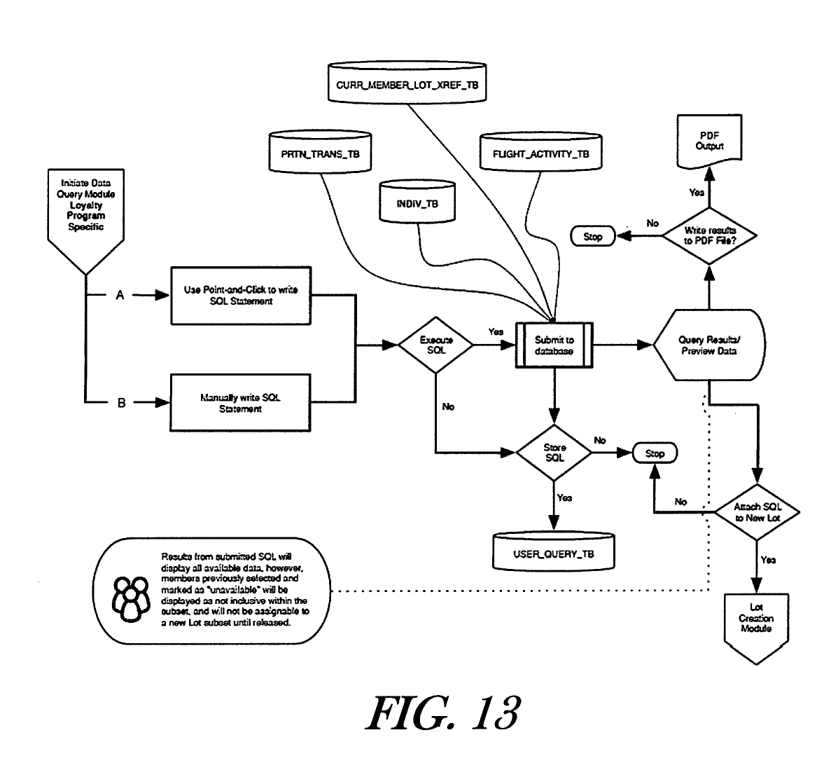

FIGS. 11-12 are example data flow diagrams for a file import into the Administration application. Preconfigured import procedures are available within the tool for files received from the Loyalty Program: (1) Individual File data (MEMBER_TB)—Total Replacement File. (2) Flight Activity data (FLIGHT_ACTIVITY_TB)—Rolling six month replacement File. (3) Partner Transaction Data (PRTN_TRANS_TB)—Rolling six month replacement file. Additionally, web activity may imported. An Appended Subset Containment file with additional web activity may be included. This file represents Individuals in an active Subset who have signed into a Loyalty Program site after the Exclusivity Start Date, and may contain the following: Individual Identification, Subset number, offer number, served date/time, and response date/time.

In various embodiments, the data files are delimited in a flat file format and conform to a predetermined file layout. Flight Activity Data and Partner Transaction Data is maintained on the database as space limitations permit. The rolling six-month file replaces records within the replacement time period. In an embodiment, all files received include the MEMBER ID or similar unique customer identifier as the primary identifying information for each record. The files may be moved to a staging area, and once loaded, made available for transfer and updating to the core database. Prior to update to the core database, the imported data may be viewable within the tool for Quality Assurance (QA) purposes. In an example embodiment, the update process to the core database is manually initiated, and is based on user permissions.

Another feature of the Administration application is Individual data analysis. FIG. 13 is an example data flow diagram for Individual analysis. An Individual is someone enrolled into one or more loyalty programs. Within the Individual data analysis tool, a user has the capability to submit queries to selected Seller data. Additionally, a user has the ability to build structured query language (SQL) statements using point-and-click functionality and the ability to manual enter SQL statements for submission.

In an example embodiment, queryable data (the universe of Subsets) is not limited. However, Individual counts will be reported on according to availability status. The total amount within the selection will include: available universe (not currently assigned to a Subset) of Individuals and the unavailable universe (currently assigned to an active Subset). In an example embodiment, the Unavailable Universe will not be available to assign to additional Subsets until those Individuals are released, even if the exclusivity periods do not intersect. All queries will be savable for future use and will be classifiable using a two-tier labeling system (folder & sub-folder). In various embodiments, results of the queries are savable to PDF files on a user's PC, for further analysis and posting to a Subset. The result set (and developed SQL) can then be utilized as the Individuals assigned to a new Subset.

In various embodiments, a series of preconfigured queries will be available for use against all Sellers and will be exportable to formatted reports. Preconfigured queries may include, but are not limited to: number of transactions in the last 6 months (average and some distribution information); points earned from Partners per month (average and some distribution information); date of enrollment (average and some distribution information); last time the Individual transacted with a Partner in that Partner category (average and some distribution information); tier breakout (percentage in each tier); primary products purchased (for example, in airline percentage for top 10 destinations); and profit contribution to the Seller (for example, in airline the percentage by class for example % who buy first versus coach domestic).

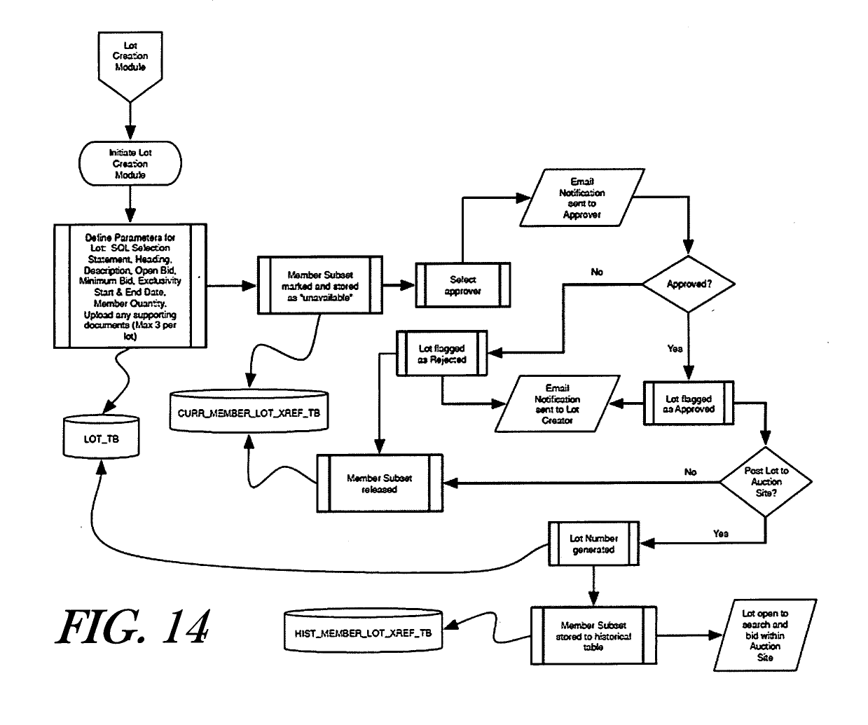

FIG. 14 is an example data flow diagram for Subset creation. In various embodiments, developed and stored SQL statements are used to create Population Subsets. A user will have the ability to assign those Individuals to a reserved Subset for auction posting. In various embodiments, users have the ability to filter the Individual data using point-and-click SQL query building and the ability to filter the Individual data using manual SQL query building.

In an example embodiment, once a set of Individuals are included within a Subset, the set is marked as “unavailable” for analysis or Subset selection within the Seller/Partner Industry combination until an Individual is released from the Subset. An Individual is released from the Subset once the exclusivity parameter expires or the Subset is rejected. After finalization of the Subset parameters, the Subset and set of Individuals are stored, and can then be submitted for approval by authorized users. If approved, the Subset creator has the ability to post the Subset to the auction site, or, if necessary, discard the Subset and release the set of Individuals back into the universe pool. If rejected, the set of Individuals will be sent back to the originator for modification or release the set of Individuals back into the universe pool. On Subset posting, the administration application will generate a unique Subset number, based on the parameters assigned to Subset Seller, and place the selected Individuals to a historical Subset selection table. In an example embodiment, the core database is updated based on the created Subsets.

In yet a further embodiment, information is exportable from the administration application. The set of Individuals assigned to a Subset are exportable upon sale of the Subset. This file will be transmitted to the Seller to the FTP location setup within the Seller configuration. The file format will be standardized to include: Individual identification, Subset Number, exclusivity start date, exclusivity end date, and Partner name. The file format specified is exemplary and may be changed.

In an embodiment, the Administration application tool has reporting features. For example, multiple standard reports may be made available from the tool. Reports for Subset activity may include data by Seller, by Partner, by date range, and by status (open, closed). Conversion performance information may include data by Seller and by Partner. Revenue Performance information may be retrieved by Seller, by Partner, and by date range.

In various embodiments, the size and set of Individuals is unknown at the time of Subset creation. For example, a Subset could be created based on future actions of Individuals. In an example embodiment the Subset may defined as “All Individuals that meet requirement ABC, during X period of time.” Or to limit the number of Individuals in the Subset, the Subset may be defined as “the first Y Individuals, that meet ABC requirement, during X period of time.” In order to account for the fact that the total number of Individuals in the Subset is unknown, the bidding price may be based on a per Individual basis up to a certain amount. For example, a Partner may place a bid for $1 for every Individual up to 20,000 Individuals. In various embodiments the Partner may not place a maximum amount such that the per Individual price is valid no matter what the size of the eventual Subset. In an embodiment, a bid may be made based on an assumed number of individuals in the Subset. For example, a Partner might pay $20,000 based on an estimate of gaining exclusivity to 20,000 individuals, and depending on the success of the promotion, the Partner may get exclusivity for 10,000 or 30,000.

By way of illustration, consider a credit card company running a promotion to sign up new customers with an offer of 0% APR. The credit card company will not know how many people are going to sign up. However, exclusive marketing rights to this the set of people (Subset) may still be auctioned off before the promotion runs. Then, in an embodiment the winner of the auction specific to this Subset would be able to have exclusivity for that audience from the very first day they have the credit card. The length of the auctioned exclusivity may be related to the offer (e.g., the time the Individual has the 0% APR available) or may be set independently.

In another example, consider an electronic retailer that tracks visitors to its website. The retailer may flag users that have been to its site and researched TV's but did not make the purchase. The retailer could then sell the exclusive marketing rights for these visitors to its Partners that sell TV's so they have access to an audience that appears to be far into the purchase process. The buyer of the subset may then be able to market to those Individuals the next time they come back to the site, in the next email from the retailer, or via retargeting.

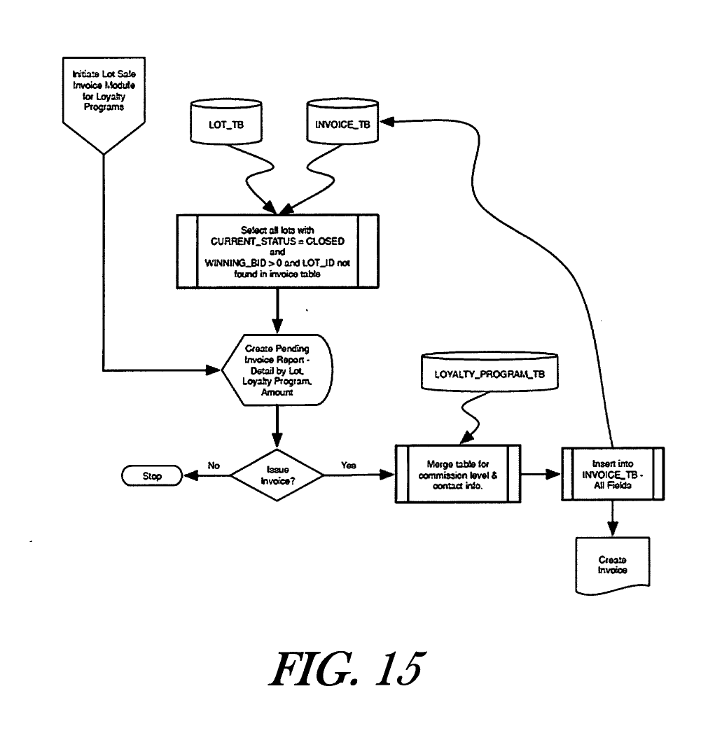

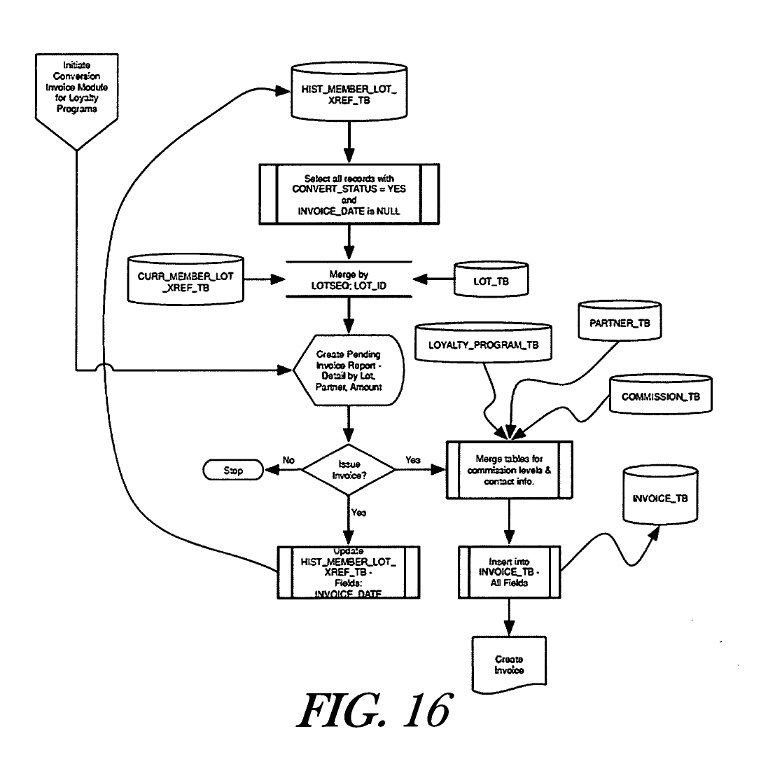

FIG. 15 illustrates an example invoicing data flow for a Subset sale. FIG. 16 illustrates an example invoicing data flow for Conversion. An automated module may be made available within the tool to generate necessary invoices. Two types of invoices may be created (1) the Subset Sale invoice, billing for the final sale of the Subset, and (2) the Conversion invoice, billing for the incremental conversion. In various embodiment, Sellers are billed monthly for all activity, and will be manually controlled by the user.

Auction Web Application

In various embodiments, the Auction application functions as the portal through which Partner users will login, search, view, and research available Subsets on which to place a bid. The auction functionality allows a user to place bids representing the maximum amount (on a per Individual basis) that the Partner entity would be willing to pay for exclusive marketing rights to the Individual. In various embodiments, a bid is a discount offer or customer service related offer. For example, a bid might be 25% off a car rental. A Partner offering 30% off a car rental would be considered a “higher” bid. In various embodiments, the bid may be a combination of a maximum amount and discount. In addition, the Auction application is a portal through which Sellers will login and view on-going activity and performance metrics related to their Individual group and view industry performance information for comparison purposes. Features of the Auction application include, but are not limited to, Login, User Experience/Dashboard, Searching available Subsets, Bidding, Account Management, Maintenance of Subset Wish List, and Question submission.

In various embodiments, login uses user authentication using unique User ID and Password and the ability to submit registration request for new users. New registration requests include, but are not limited to: Full name, Company, Company Address, Email address, and Phone Number.

A Seller dashboard may include: Active Subsets, Closed Subsets, Timeline of exclusivity for Partners, and Click-Thru capability on Subset Numbers to retrieve additional data. The click-thru capability may include data by Subset for: percentage of Individuals converted, Avg. days to conversion, and Cost per conversion.

In various embodiments, multiple Partners may bid for certain segments of Individuals that overlap. For example consider Partner 1 that is interested in adults 25 and over who make $60,000 or more per year and consider that Partner 1 is willing to pay up to $2 per Individual. Now, consider Partner 2 is interested in adults 40 and over who make $60,000 or more per year and live in the South. Partner 2 is willing to pay up to $2.50 per Individual. The Overlapping Subset of Individuals is adults 40 and over who make $60,000 per year and live in the South. Thus, Partner 2 will win the overlapping Individuals with its $2.50 bid and Partner 1 will win the rest of the Individuals at its $2 bid. While the previous example use demographics as a filter on the Individuals, Partners may bid on any criteria used to create a Subset. For example, Partner 1 may bid on adults age 25-40 which agreed to 0% APR credit card offer while Partner 2 may bid on all adults which agreed to the 0% APR credit card offer. The determination of which Partner wins which portion of the adults who accepted the offer is based on the bids each Partner has placed.

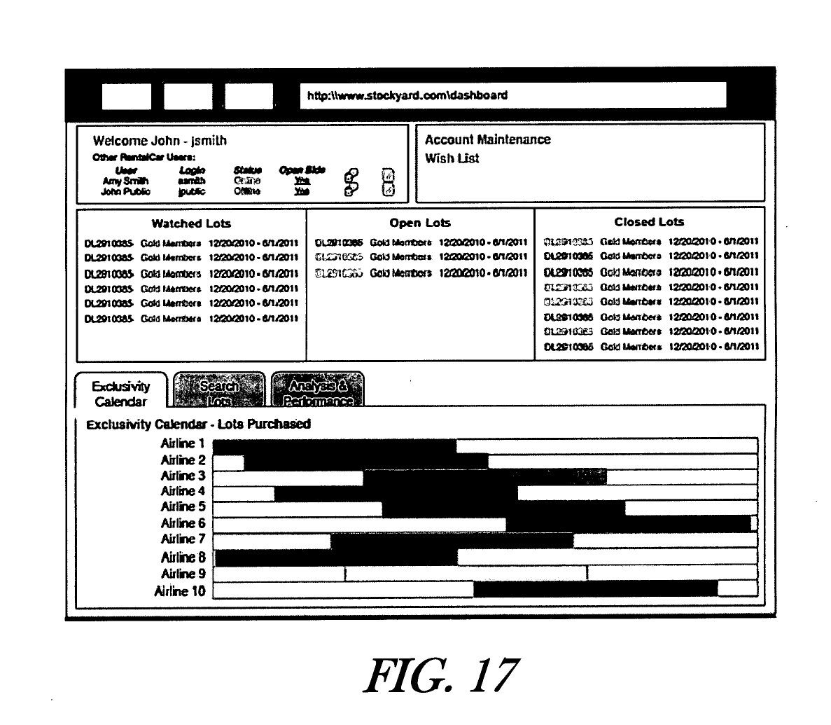

FIG. 17 illustrates an example user interface of a Partner User Interface. A Partner dashboard may include: Watched Subsets, Active Subset (with bids from users), Closed Subsets (indicating “Won” or “Lost”), Timeline of exclusivity within Sellers, On-line status and bid activity of all users within the Partner entity, and Click-Thru capability for additional information on Subsets. The click-thru capability may include data by Subset for: percentage of Individuals converted, Avg. days to conversion, and Cost per conversion.

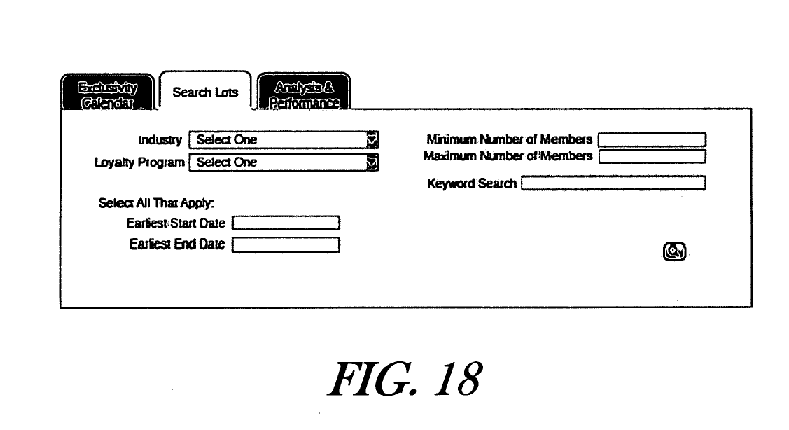

FIG. 18 illustrates an example user interface for searching Subsets. In an example embodiments, the search functionality of the Auction application allows users to search open Subsets using multiple search criteria. Search Criteria may include, but is not limited to, Seller Name, Number of Individuals available, Exclusivity Start Date, Exclusivity End Date, and Key word (in heading or description). Within each Subset, the user has the ability to download and view attached supporting documentation (reports) for that Subset (e.g., in PDF, .docx format).

In various embodiments, users place bids on any open Subset on behalf of the Partner that he/she represents. Users from the same Partner can bid simultaneously. However, all users from the same Partner submit bids for the single Partner entity, and therefore, the highest bidder from the Partner entity is the superseding bid for that Partner. A user may enter (e.g., using an input device such as a keyboard) a maximum amount he or she is willing to pay (Proxy Bid). In an example embodiment, the Auction application System will automatically update bid amount in set increments up to the maximum authorized by the user. Users from the same Partner effectively bid as a team. The maximum amount entered is the maximum amount authorized for the Partner, not the individual.

In various embodiments in which the bid is based on a discount or customer service offering, the Auction application System may not automatically update bidding amounts or determine the highest bidder. For example, if a Partner offers a bid of five dollars per member and 20% off a car rental, the Auction application System may send a notification to an administrator of the auction such as a representative of the Seller. The representative makes a decision as to whether the offer from the Partner is “higher” or better than any existing offers. If the offer is considered the best, the Auction application System will update the Subset to reflect the new current high bid. If the bid is considered lower than the current offer, the Auction application System may notify the Partner that its offer has been rejected.

In an example embodiment, a user has the ability to update contact information on the account (email, phone, etc).

In various embodiments users have the ability to maintain a Subset wish list. Users may have the ability to submit requests to the Seller indicating specialized Subset configurations, if the configuration is not currently available. For example, a user may wish to bid on a Subset of fliers who travel at least once every two weeks. Additionally, users have the opportunity to submit Subset specific questions within the Subset description page.

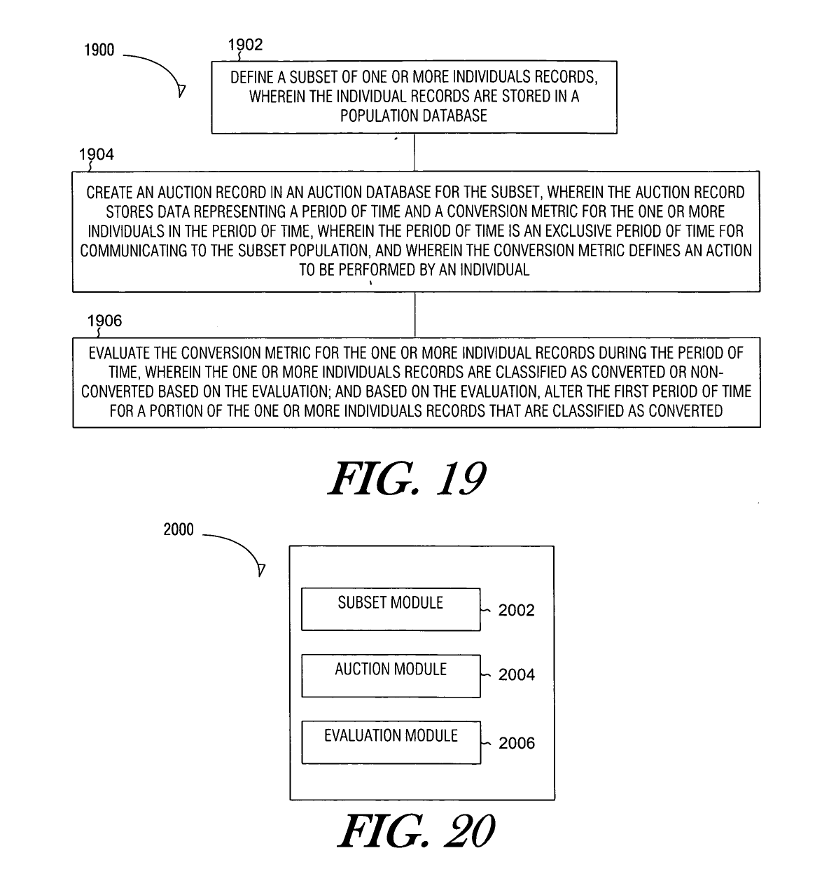

FIG. 19 is a flow chart illustrating a method 1900, in accordance with an example embodiment, to generate an auction. Method 1900 may be performed by any of the modules, logic, or components described herein.

At block 1902, in an embodiment, a subset of one or more individuals records is defined, wherein the individual records are stored in a population database. In an embodiment, the individual records may be stored as member records and stored in one or more tables as illustrated in FIG. 4 and discussed herein. In an embodiment, the subset is the Member subset as described and discussed in FIG. 14. In an embodiment, the exact number and size of the subset is unknown at the time of creation.

At block 1904, in an embodiment, an auction record is created in an auction database for the subset, wherein the auction record stores data representing a period of time and a conversion metric for the one or more individuals in the period of time, wherein the period of time is an exclusive period of time for communicating to the subset population, and wherein the conversion metric defines an action to be performed by an Individual. In an embodiment, the auction record is a lot as described in FIGS. 4 and 14 and described herein. The conversion metric and period of time may be stored as data associated with the lot.

At block 1906, in an embodiment, the conversion metric for the one or more individual records is evaluated during the period of time, wherein the one or more individuals records are classified as converted or non-converted based on the evaluation. In an embodiment, based on the evaluation, the first period of time is extended for a portion of the one or more individuals records that are classified as converted. In an embodiment, the individual records may be updated to reflect the converted status of the Individual.

FIG. 20 is an example system 2000. Illustrated is subset module 2002, auction module 2004, and evaluation module 2006. The names of the modules are intended to exemplary in nature. The modules may also perform other functionality as described elsewhere in this document.

In an embodiment, subset module 2002 is configured to define a subset of one or more individuals.

In an embodiment, auction module 2004 is configured to create an auction record in an auction database for the subset, wherein the auction record stores data representing a period of time and a conversion metric for the one or more individuals in the period of time, and wherein the period of time is an exclusive period of time for communicating to the subset population.

In an embodiment, evaluation module 2006 is configured to evaluate the conversion metric for the one or more individual records during the period of time, wherein the one or more individuals records are classified as converted or non-converted based on the evaluation; and based on the evaluation, extend the first period of time for a portion of the one or more individuals records that are classified as converted.

Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly; the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).

### Example Machine Architecture and Machine-Readable Medium

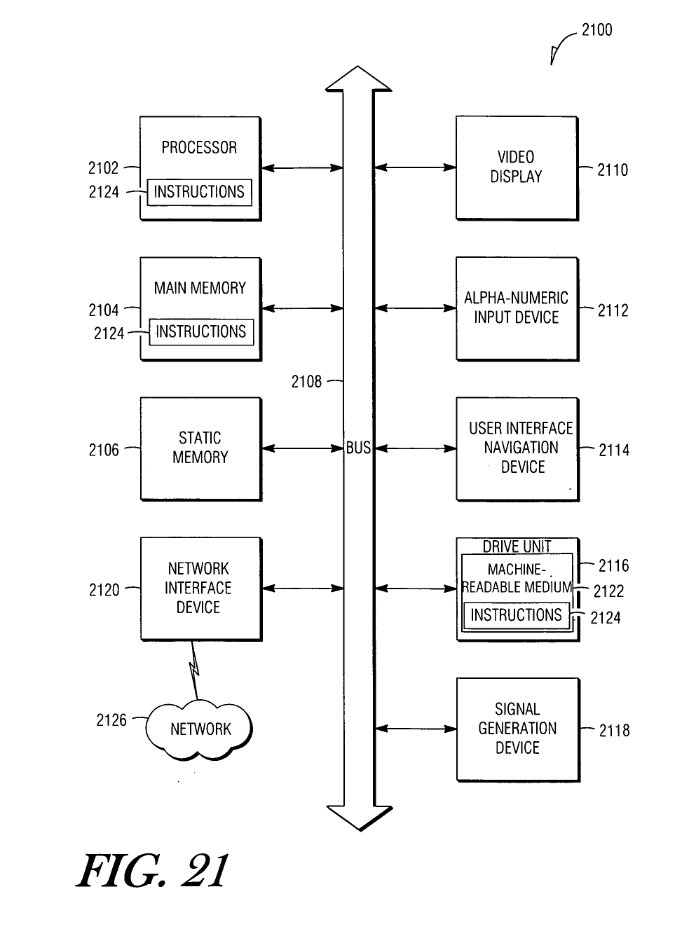

FIG. 21 is a block diagram of machine in the example form of a computer system 2100 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2100 includes a processor 2102 (e.g., a central processing unit (CPU), a graphics processing unit (GPU) or both), a main memory 2104 and a static memory 2106, which communicate with each other via a bus 2108. The computer system 2100 may further include a video display unit 2110 (e.g., a liquid crystal display (LCD) or a cathode ray tube (CRT)). The computer system 2100 also includes an alphanumeric input device 2112 (e.g., a keyboard), a user interface (UI) navigation device 2114 (e.g., a mouse), a disk drive unit 2116, a signal generation device 2118 (e.g., a speaker) and a network interface device 2120.

### Machine-Readable Medium

The disk drive unit 2116 includes a machine-readable medium 2122 on which is stored one or more sets of instructions and data structures (e.g., software) 2124 embodying or utilized by any one or more of the methodologies or functions described herein. The instructions 2124 may also reside, completely or at least partially, within the main memory 2104 and/or within the processor 2102 during execution thereof by the computer system 2100, the main memory 2104 and the processor 2102 also constituting machine-readable media.

While the machine-readable medium 2122 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 2124 may further be transmitted or received over a communications network 2126 using a transmission medium. The instructions 2124 may be transmitted using the network interface device 2120 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

It is to be understood that the above description is intended to be illustrative, and not restrictive. For example, the above-illustrated embodiments (and/or aspects thereof) may be used in combination with each other. Many other embodiments may be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

What is claimed is:

1. A system comprising:
a subset module configured to define a subset of one or more individuals;
an auction module configured to create an auction record in an auction database for the subset, wherein the auction record stores data representing a period of time and a conversion metric for the one or more individuals in the period of time, and wherein the period of time is an exclusive period of time for communicating to the subset population; and
an evaluation module to:
evaluate the conversion metric for the one or more individual records during the period of time, wherein the one or more individuals records are classified as converted or non-converted based on the evaluation; and
based on the evaluation, extend the first period of time for a portion of the one or more individuals records that are classified as converted.

2. The system of claim 1, wherein the evaluation module is evaluate the conversion metric by transmitting a cookie to a computing device of an individual of the one or more individuals; and tracking, via the cookie, viewing of offers by the individual.

3. The system of claim 1, wherein the subset module is to define the subset of one or more individuals based on future actions of the one or more individuals.

4. A method comprising:
defining a subset of one or more individuals records, wherein the individual records are stored in a population database;
creating an auction record in an auction database for the subset, wherein the auction record stores data representing a period of time and a conversion metric for the one or more individuals in the period of time, and wherein the period of time is an exclusive period of time for communicating to the subset population;
evaluating the conversion metric for the one or more individual records during the period of time, wherein the one or more individuals records are classified as converted or non-converted based on the evaluation; and
based on the evaluation, extending the first period of time for a portion of the one or more individuals records that are classified as converted.

5. The method of claim 4, further comprising:
determining a winner of the auction; and
granting exclusive communication rights to the individuals in the subset to the winner of the auction.

6. The method of claim 4, further comprising:
storing in a database one or more individual records, wherein an individual record comprises a datafield representing a point total of an individual record.

7. The method of claim 6, wherein evaluating the conversion metric for the one or more individuals during the period of time comprises:
comparing the data stored in the datafield representing a point total of an individual record at the beginning of the period of time with the data stored in the datafield when the datafield is updated.

8. The method of claim 4, wherein evaluating the conversion metric for the one or more individuals during the period of time comprises:
tracking transactions made by the one or more individuals with a winner of the auction.

9. The method of claim 4, wherein the conversion metric is based on viewing an offer of a winner of the auction.

10. A non-transitory machine-readable medium comprising instructions, which when executed by one or more processors, cause the one or more processors to:
define a subset of one or more individuals records, wherein the individual records are stored in a population database;
create an auction record in an auction database for the subset, wherein the auction record stores data representing a period of time and a conversion metric for the one or more individuals in the period of time, wherein the period of time is an exclusive period of time for communicating to the subset population, and wherein the conversion metric defines an action to be performed by an Individual;
evaluate the conversion metric for the one or more individual records during the period of time, wherein the one or more individuals records are classified as converted or non-converted based on the evaluation; and
based on the evaluation, alter the first period of time for a portion of the one or more individuals records that are classified as converted.

11. The non-transitory machine-readable medium of claim 10, further comprising instructions to cause the one or more processors to:
determine a winner of the auction; and
grant exclusive communication rights to the individuals in the subset to the winner of the auction.

12. The non-transitory machine-readable medium of claim 11, further comprising instructions to cause the one or more processors to:
update the auction record with an identification of the winner.

13. The non-transitory machine-readable medium of claim 10, further comprising instructions to cause the one or more processors to:
store in a database one or more individual records, wherein an individual record comprises a datafield representing a conversion status of an individual record.

14. The non-transitory machine-readable medium of claim 13, wherein the instructions to evaluate the conversion metric for the one or more individuals during the period of time comprise instructions to cause the one or more processors to:
receive data indicating an individual has completed the action defined in the conversion metric; and
update the datafield representing the conversion status of the individual to indicate a status of converted.

15. The non-transitory machine-readable medium of claim 10, further comprising instructions to cause the one or more processors to:
based on the evaluation, update an individual record as available when an individual record is classified as non-converted at the end of the period of time.
